(19) United States
(12) Patent Application Publication
(10) Pub. No.: US 2018/0023608 A1
(43) Pub. Date: Jan. 25, 2018

(54) FASTENER FOR FASTENING A RESIN COMPONENT

(71) Applicant: TOYOTA BOSHOKU KABUSHIKI KAISHA, Aichi-ken (JP)

(72) Inventor: Iwao MATSUSHIMA, Aichi-ken (JP)

(73) Assignee: TOYOTA BOSHOKU KABUSHIKI KAISHA, Aichi-ken (JP)

(21) Appl. No.: 15/651,171

(22) Filed: Jul. 17, 2017

(30) Foreign Application Priority Data
Jul. 25, 2016 (JP) 2016-145585

(51) Int. Cl. F16B 19/10; F16B 2/24; F16B 13/02; F16F 1/373

(52) U.S. Cl. CPC F16B 19/10; F16F 1/3732; F16B 2/24; F16B 13/02; F16B 1/00

(57) ABSTRACT

Provided is a fastener for fastening a resin component. The fastener is interposed between an insertion hole provided in the resin component and a fastening member inserted through the insertion hole. The fastener includes: an insertion portion having a tubular shape and insertable through the insertion hole in a non-press-fitted state; a flange portion protruding radially outward of the insertion portion from an end portion of the fastener; and a recessed portion provided on an outer surface of the insertion portion. In the state where the insertion portion is inserted through the insertion hole, the flange portion is disposed outside the insertion hole, and a projecting portion protruding from an inner surface of the insertion hole is disposed in the recessed portion of the insertion portion.

### INCORPORATION BY REFERENCE

The disclosure of Japanese Patent Application No. 2016-145585 filed on Jul. 25, 2016 including the specification, drawings and abstract is incorporated herein by reference in its entirety.

### BACKGROUND

### 1. Technical Field

The disclosure relates to a fastener for fastening a resin component, and more specifically relates to a fastener that is interposed between an insertion hole provided in a resin component and a fastening member such as a bolt member.

### 2. Description of Related Art

A bush as this type of fastener that is used for fastening between resin component and a metal component has a moderate hardness and includes a tubular insertion portion and a disc-shaped flange portion. When fastening the resin component and the metal component to each other, a bolt member as a fastening member is inserted through an insertion hole of the resin component via the bush and screwed into a nut on the metal component side so as to be fixed. In this event, the flange portion disposed outside the insertion hole receives the pressure from the bolt member to prevent excessive deformation of the resin component that is otherwise caused by the tightening pressure of the bolt member, so that it is possible to prevent or reduce the lowering of fastening axial force due to deformation of the resin component.

In terms of preventing coming-off from the resin component, this type of bush is press-fitted into the insertion hole of the resin component or integrated with the resin component by insert molding or the like. For example, a bush disclosed in Japanese Patent Application Publication No. 06-167258 (JP 06-167258 A) includes a tubular insertion portion, a collar portion corresponding to a flange portion, and a projecting portion. The projecting portion is a convex part protruding radially outward of the insertion portion on the leading end side of the insertion portion and can be locked to a stepped portion provided on an inner surface of an insertion hole. By press-fitting the insertion portion of the bush into the insertion hole and locking the projecting portion of the bush to the stepped portion of the insertion hole, it is possible to more reliably prevent coming-off of the bush from the insertion hole.

### SUMMARY

In the meantime, the configuration in which the bush is press-fitted into or integrated with the resin component requires a dedicated facility and process and therefore cannot be easily employed in terms of improving the workability, in terms of reducing the manufacturing cost, and so on. Further, when the bush is press-fitted into the insertion hole to strongly interfere with the inner surface of the insertion hole, it takes time to detach the bush, for example, in the maintenance work. Naturally, it is also possible to insert the bush through the insertion hole in a non-press-fitted state without using a special tool, but, in that case, the possibility of coming-off of the bush from the resin component is extremely increased. The disclosure provides a fastener that can be attached to a resin component in such a way as to be detachable more smoothly while coming-off of the fastener from the resin component is prevented as much as possible.

According to an aspect of the disclosure, a fastener for fastening a resin component, the fastener configured to be interposed between an insertion hole provided in the resin component and a fastening member inserted through the insertion hole, includes: an insertion portion having a tubular shape and insertable through the insertion hole in a non-press-fitted state; a flange portion protruding radially outward of the insertion portion from an end portion of the fastener; and a recessed portion provided on an outer surface of the insertion portion. In the state where the insertion portion is inserted through the insertion hole, the flange portion is disposed outside the insertion hole, and a projecting portion protruding from an inner surface of the insertion hole is disposed in the recessed portion of the insertion portion. In this type of configuration, it is desirable that the fastener be attached to the resin component in such a way as to be detachable more smoothly while preventing coming-off of the fastener from the resin component as much as possible. In this aspect, since the tubular insertion portion is inserted through the insertion hole in the non-press-fitted state, it is possible to smoothly attach and detach the fastener to and from the resin component. The pressure from, for example, a bolt member as the fastening member is received by the flange portion disposed outside the insertion hole, and the projecting portion protruding from the inner surface of the insertion hole is disposed in the recessed portion of the insertion portion. Therefore, while fulfilling the function as the fastener, it is also possible to suitably restrict the movement of the insertion portion in a coming-off direction with respect to the insertion hole by interference between the projecting portion and the recessed portion.

In the above-described aspect, the depth from an opening of the recessed portion to its bottom may be greater than the projecting portion. In this configuration, by setting the depth from the opening of the recessed portion to its bottom to be greater than the projecting portion, smooth relative movement of the fastener is made possible.

In the above-described aspect, the fastener may be a nut for the fastening member. In the above-described aspect, the insertion portion may include an abutting portion formed by cutting out the outer surface of the insertion portion into a flat surface. In this configuration, the abutting portion of the insertion portion abuts against a rotation preventing portion of the insertion hole to restrict the rotational motion of the fastener, so that the fastener can be suitably used as the nut.

According to the above-described aspect, the fastener can be attached to the resin component in such a way as to be detachable more smoothly while coming-off of the fastener from the resin component is prevented as much as possible.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view of a vehicle seat;

FIG. 2 is a perspective view of a portion of a seat back and a bracket member;

FIG. 3 is a rear perspective view of a portion of the seat back with a seat frame exposed;

FIG. 4 is a perspective view of a portion of the bracket member;

FIG. 5 is an enlarged top view of a portion of the bracket member, wherein a resin component is shown;

FIG. 6 is a sectional view of a portion of the bracket member taken along line VI-VI of FIG. 5;

FIG. 7 is a perspective view of a fastener;

FIG. 8 is a top view of the seat back and a skeleton portion of the bracket member;

FIG. 9 is a sectional view of the bracket member taken along line IX-IX of FIG. 8;

FIG. 10 is an enlarged sectional view of the fastener corresponding to an encircled portion identified by symbol X of FIG. 9;

FIG. 11 is a perspective view of a portion of a bracket member and a fastener according to Example 2;

FIG. 12 is a perspective view of a fastener according to Example 3;

FIG. 13 is an exploded perspective view showing the fastener, a bolt member, and corresponding fastening seats according to Example 3;

FIG. 14 is a sectional view of the fastener, the bolt member, and the corresponding fastening seats according to Example 3;

FIG. 15 is another sectional view of the fastener, the bolt member, and the corresponding fastening seats according to Example 3;

FIG. 16 is a perspective view of a fastening seat according to Modification 1;

FIG. 17 is a perspective view of a fastening seat according to Modification 2;

FIG. 18 is a perspective view of a fastener according to Modification 2;

FIG. 19 is a perspective view at another angle of the fastener according to Modification 2;

FIG. 20 is a perspective view of a fastener according to Modification 3;

FIG. 21 is a perspective view at another angle of the fastener according to Modification 3;

FIG. 22 is a perspective view of a fastener according to Modification 4; and

FIG. 23 is a perspective view at another angle of the fastener according to Modification 4.

### DETAILED DESCRIPTION OF EMBODIMENTS

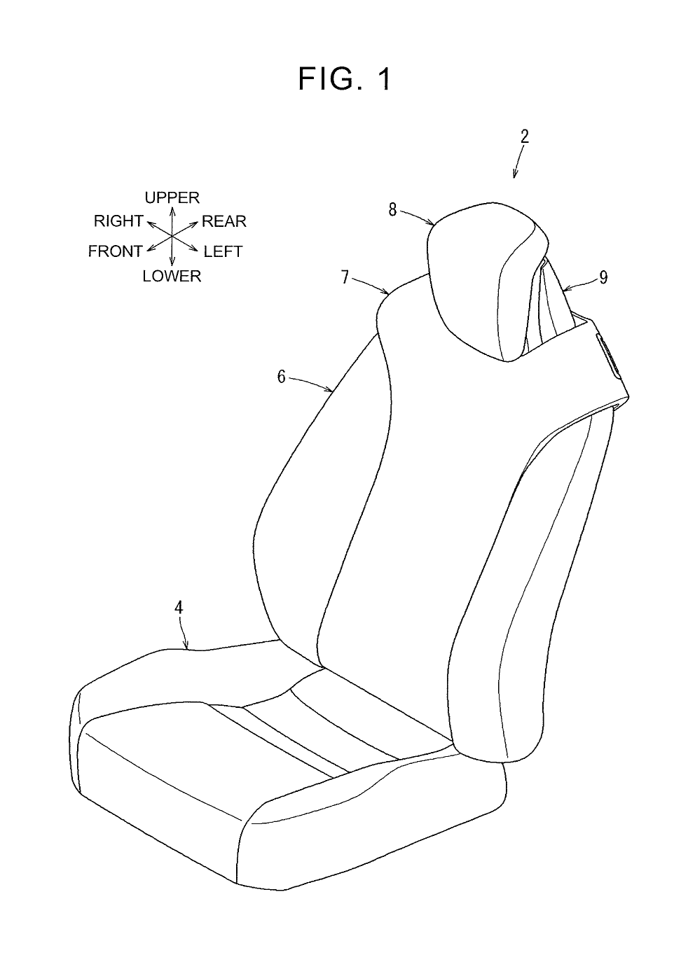

Hereinbelow, an embodiment for carrying out the disclosure will be described with reference to FIGS. 1 to 23. In the figures, arrows indicating front and rear directions, right and left directions, and upper and lower directions of a vehicle seat are shown as appropriate. A vehicle seat 2 of FIG. 1 includes a seat cushion 4, a seat back 6, a bracket member 7, a headrest 8, and a cover member 9. A lower portion of the seat back 6 is tiltably coupled to a rear portion of the seat cushion 4, and the headrest 8 is disposed at an upper portion of the seat back 6 in a standing state. Bar-shaped headrest stays (not shown) protrude on the lower right and left sides of the headrest 8, and these right and left headrest stays are inserted into the seat back 6. The cover member 9 is disposed in a gap between the seat back 6 and the headrest 8. The cover member 9 is disposed so as to cover the right and left headrest stays in the rear of the headrest 8.

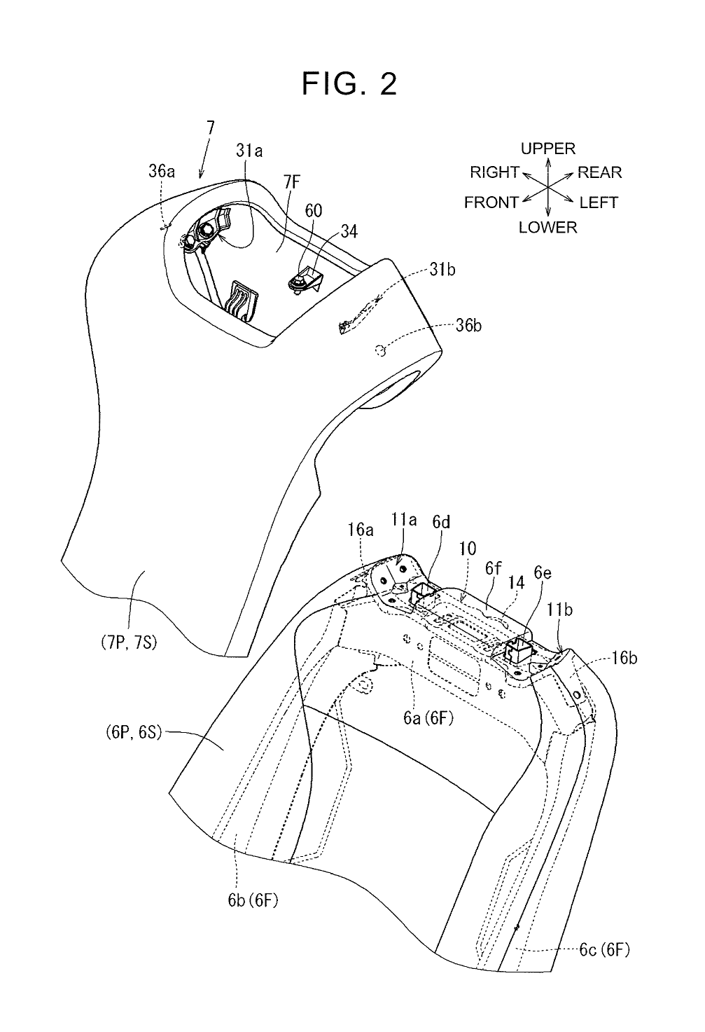

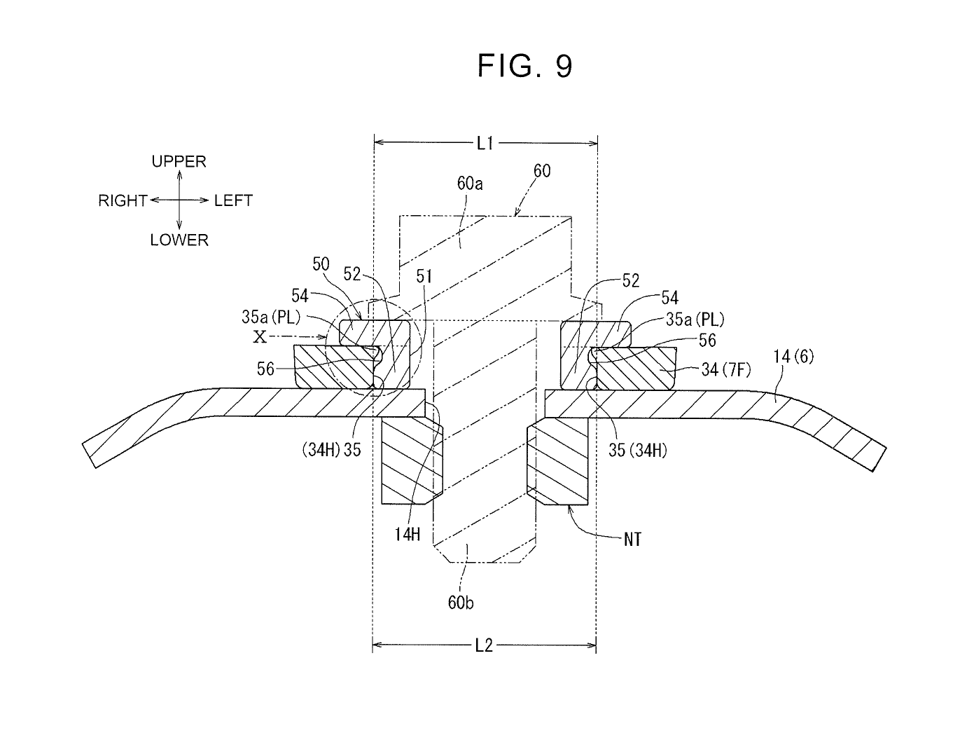

Example 1 Referring to FIG. 1, the bracket member 7 having a generally Y-shape in front view is disposed on the outer surface side of the seat back 6, and a portion of the seat back 6 from its right and left shoulders to its front surface is covered by the bracket member 7 (details of the respective members will be described later as appropriate). Referring to FIG. 2, the bracket member 7 is provided with a middle fastening seat 34 at a frame portion 7F as a resin component as will be described later, and the middle fastening seat 34 is fastened and fixed to a corresponding rear fastening seat 14 on the seat back 6 side. In this event, referring to FIG. 9, a shaft portion 60b of a bolt member 60 as a fastening, member is inserted through an upper insertion hole 34H of the middle fastening seat 34 via a later-described fastener 50. In this type of configuration, it is desirable that the fastener 50 be attached to the middle fastening seat 34 in such a way as to be detachable more smoothly while preventing coming-off of the fastener 50 from the middle fastening seat 34 as much as possible. Therefore, in this Example, by later-described configurations, the fastener 50 is attached to the middle fastening seat 34 in such a way as to be detachable more smoothly while preventing coming-off of the fastener 50 from the middle fastening seat 34 as much as possible. Hereinbelow, the respective configurations will be described in detail.

Seat Back

Referring to FIG. 2, the seat back 6 is a member having a generally rectangular shape in front view and serving as a backrest for a seated occupant and includes a seat pad 6P, a seat cover 6S, a seat frame 6F, and a fastening component 10. The seat pad 6P is a member forming the external shape of the seat and capable of elastically supporting the occupant and is disposed on the front surface side of the later-described seat frame 6F. While the material of the seat pad 6P is not particularly limited, the seat pad 6P may be made of, for example, a resin foam such as a polyurethane foam (density: 10 kg/m³ to 60 kg/m³). The seat cover 6S is a surface member covering the seat pad 6P and the seat frame 6F and may be made of, for example, a fabric (woven fabric, knitted fabric, nonwoven fabric) or a leather (natural leather, synthetic leather).

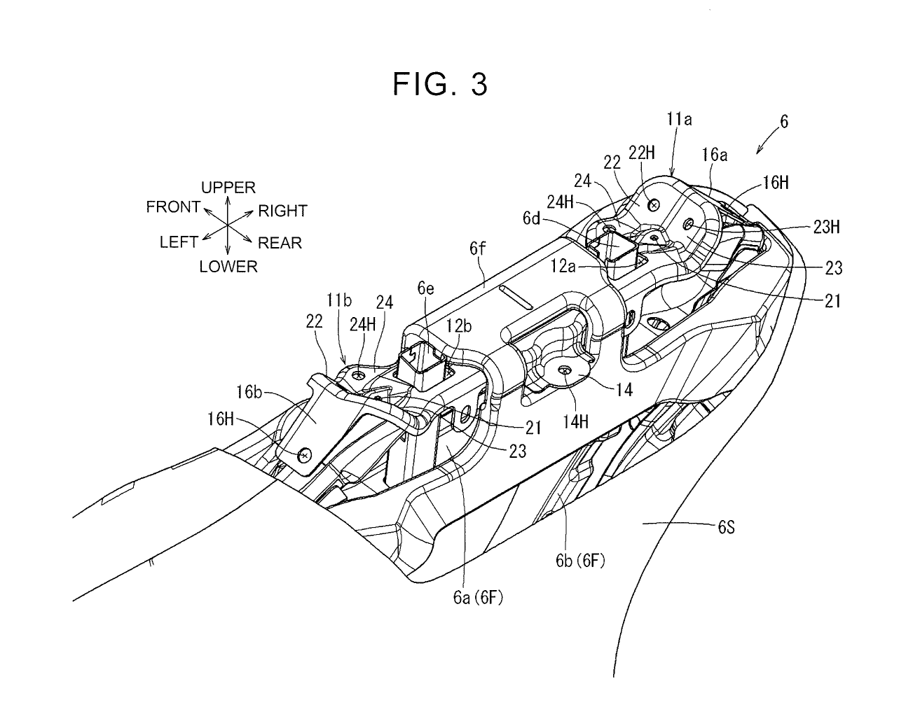

The seat frame 6F is a generally arch-shaped frame member made of a metal and forming a skeleton portion of the seat back 6 and, referring to FIG. 2, includes an upper frame 6a and a pair of right and left side frames 6b and 6c. The right and left side frames 6b and 6c are respectively plate-like parts forming the side skeletons and are disposed at an appropriate interval therebetween in the right-left direction. The upper frame 6a is a generally prism-shaped part forming the upper skeleton and is bridged between upper portions of the right and left side frames 6b and 6c. Headrest supports 6d and 6e protrude on the upper right and left sides of the upper frame 6a. The right and left headrest supports 6d and 6e are tubular members through which the corresponding headrest stays (not shown) can be respectively inserted, and are fixed to the upper frame 6a while vertically passing through the upper frame 6a. Referring to FIGS. 2 and 3, a protective member 6f is disposed at an upper portion of the seat frame 6F and covers, from above, a front surface, an upper surface, and a rear surface of the upper frame 6a. The protective member 6f is cut out into appropriate shapes at its right and left shoulders and at its rear center, and portions (fastening seats 11a, 11b, 14, 16a, 16b, etc.) of the later-described fastening component 10 are exposed to the outside from these cut-out portions.

Referring to FIGS. 2 and 3, the fastening component 10 is a plate member of a metal or a hard resin elongated in the seat width direction and having a generally rectangular shape in top view and is disposed on the upper surface of the upper frame 6a. The fastening component 10 includes a pair of right and left lower fastening seats 11a and 11b, a pair of right and left fitting portions 12a and 12b, the rear fastening seat 14, and a pair of right and left protruding fastening seats 16a and 16b. The peripheral edge of the fastening component 10 is bent downward in terms of ensuring the strength. The fitting portions 12a and 12b are generally rectangular through-holes provided on the right and left sides of the fastening component 10, and the corresponding headrest supports 6d and 6e can be respectively inserted through the fitting portions 12a and 12b. In this Example, the fastening component 10 is disposed on the upper surface of the upper frame 6a in a state where the corresponding headrest supports 6d and 6e are respectively inserted through the fitting portions 12a and 12b. A portion, sandwiched between the right and left headrest supports 6d and 6e, of the fastening component 10 is covered by the protective member 6f along with the upper surface of the upper frame 6a.

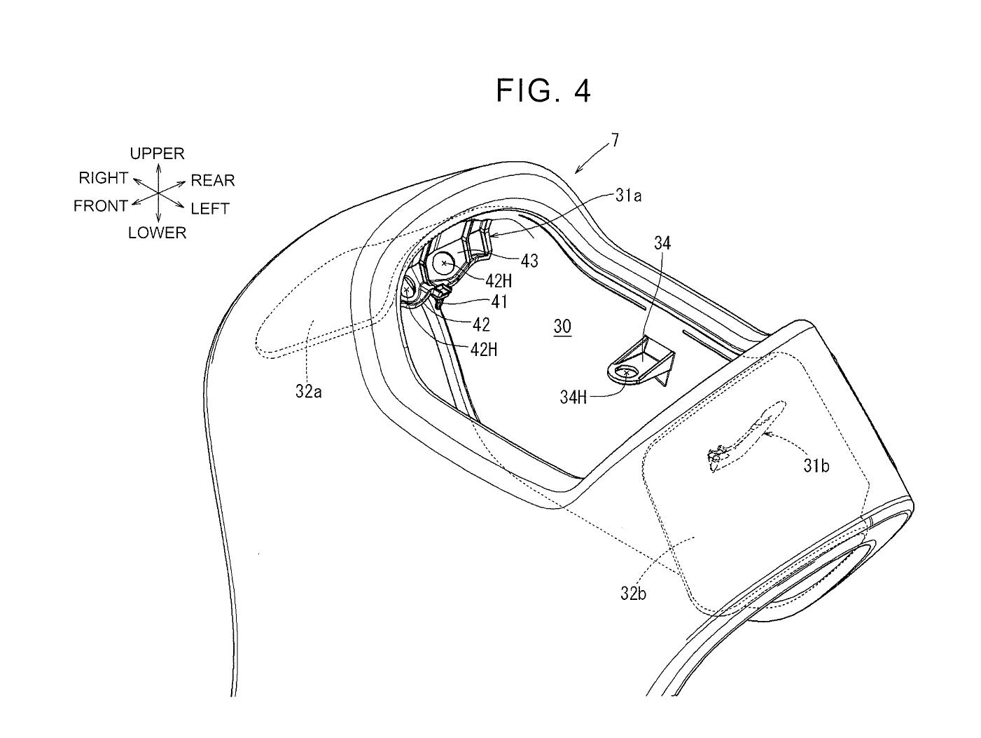

The right lower fastening seat 11a is a part having a generally rectangular shape in top view and forming a right end of the fastening component 10 and is disposed near the right shoulder of the upper frame 6a. The left lower fastening seat 11 b is a part having a generally rectangular shape in top view and forming a left end of the fastening component 10 and is disposed near the left shoulder of the upper frame 6a. The right and left lower fastening seats 11a and 11b have substantially the same basic configuration and are disposed symmetrically with each other. Referring to FIG. 3, the right lower fastening seat 11a, for example, includes a positioning hole portion 21, a front lower fastening part 22, a rear lower fastening part 23, and an auxiliary fastening part 24 that are integrally formed. The positioning hole portion 21 is a through-hole provided on the outer side of the right fitting portion 12a, and a positioning projecting portion 41 of a later-described upper fastening seat 31a shown in FIG. 4 can be inserted through the positioning hole portion 21. The auxiliary fattening part 24 is a flat plate part disposed around the positioning hole portion 21 and is provided at its front portion with a through-hole 24H. For example, a locking member (not shown) fixed to an end portion of the seat cover 6S can be inserted through and fixed to the through-hole 24H of the auxiliary fastening part 24. The front lower fastening part 22 is a flat plate part formed of an upper-surface front portion at a right end of the lower fastening seat 11a. A generally circular insertion hole 22H being a through-hole is provided at the center of the front lower fastening part 22. The rear lower fastening part 23 is a flat plate part formed of an upper-surface rear portion at the right end of the lower fastening seat 11a and is continuous with a rear end of the front lower fastening part 22. A generally circular insertion hole 23H being a through-hole is provided also at the center of the rear lower fastening part 23.

Referring to FIG. 3, the rear fastening seat 14 is a flat plate part protruding rearward from a rear surface of the fastening component 10 and is disposed in the middle of the fastening component 10 in its longitudinal direction. The middle fastening seat 34 of the bracket member 7 shown in FIG. 2 is fastened and fixed to a lower insertion hole 14H of the rear fastening seat 14 via the later-described bolt member 60 and fastener 50. The lower insertion hole 14H is a through-hole having a generally circular shape in top view and has a diameter that allows the later-described bolt member 60 to be detachably inserted therethrough. The protruding fastening seats 16a and 16b are flat plate parts respectively protruding from the right and left edges of the fastening component 10 while being curved downward. Corresponding side fastening seats 36a and 36b of the later-described bracket member 7 shown in FIG. 2 are respectively fastened and fixed to insertion holes 16H on the leading end sides of the protruding fastening seats 16a and 16b.

Bracket Member

The bracket member 7 is a member disposed on the outer surface side of the seat back 6 and, referring to FIGS. 2 and 4, includes a pad portion 7P, a skin portion 7S, and the frame portion 7F. The pad portion 7P is a member covering the front surface of the seat back 6 and having a generally Y-shape in front view and may be made of the exemplified material of the seat pad 6P. The upper side of the pad portion 7P is disposed so as to cover an outer surface of the later-described frame portion 7F. The skin portion 7S is a surface member covering a surface of the pad portion 7P and may be made of the exemplified material of the seat cover 6S.

Frame Portion (Resin Component)

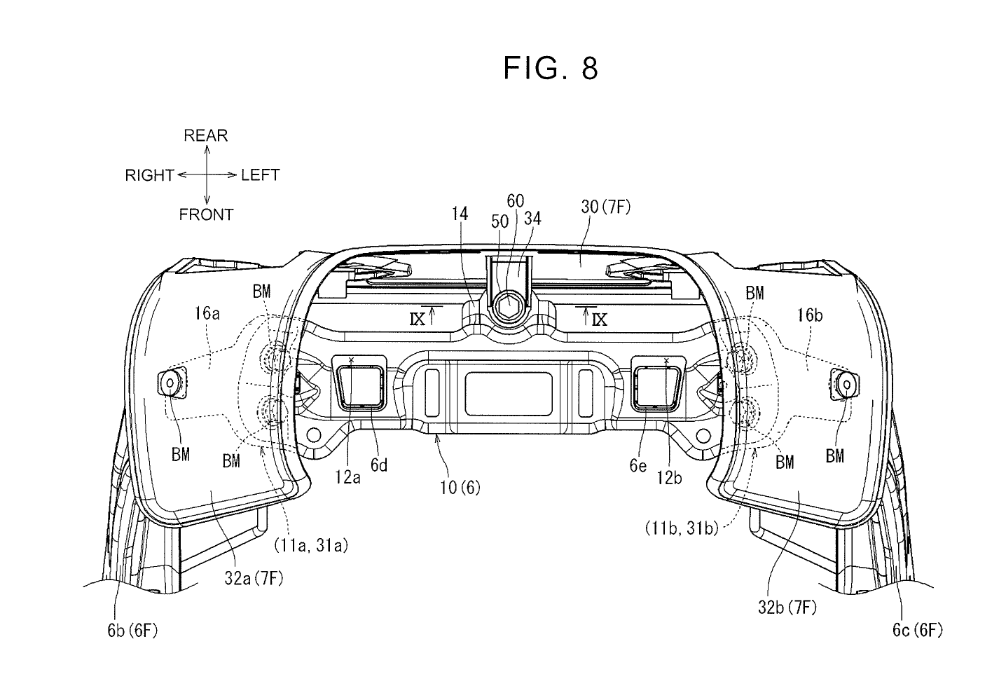

Referring to FIGS. 4 and 8, the frame portion 7F is a plate-like member forming a skeleton portion of the bracket member 7 and may typically be made of a hard resin. The type of hard resin as the material of the frame portion 7F is not particularly limited as long as the strength required for the frame portion 7F can be ensured. The frame portion 7F includes a body portion 30, a pair of right and left upper fastening seats 31a and 31b, a pair of right and left shoulder hanging portions 32a and 32b, the middle fastening seat 34, and the pair of right and left side fastening seats 36a and 36b. The body portion 30 is a generally rectangular part disposed in the rear of the upper frame 6a shown in FIG. 2. The right shoulder hanging portion 32a is a part protruding forward and upward from a right end of the body portion 30 and is disposed so as to cover the right shoulder of the upper frame 6a shown in FIG. 2. The left shoulder hanging portion 32b is a part protruding forward and upward from a left end of the body portion 30 and is disposed so as to cover the left shoulder of the upper frame 6a shown in FIG. 2. Referring to FIG. 8, the right and left side fastening seats 36a and 36b are hole portions passing through the corresponding shoulder hanging portions 32a and 32b in the thickness direction. The corresponding protruding fastening seats 16a and 16b of the fastening component 10 shown in FIG. 2 are respectively fastened and fixed to the right and left side fastening seats 36a and 36b.

Referring to FIG. 4, the right upper fastening seat 31a is a flat plate part rising from an inner surface of the right shoulder hanging portion 32a and is disposed so as to face the right lower fastening seat 11a shown in FIG. 2. The left upper fastening seat 31b is a flat plate part rising from an inner surface of the left shoulder hanging portion 32b and is disposed so as to face the left lower fastening seat 11b shown in FIG. 2. The upper fastening seats 31a and 31b have substantially the same basic configuration and are disposed symmetrically with each other. Referring to FIG. 4, the right upper fastening seat 31a, for example, is a generally rectangular flat plate part elongated in the seat front-rear direction and includes the positioning projecting portion 41, a front upper fastening part 42, and a rear upper fastening part 43 that are integrally formed. The positioning projecting portion 41 is a claw-shaped part protruding downward at a left end of the upper fastening seat 31a and is disposed at a position where the positioning projecting portion 41 can be inserted through the positioning hole portion 21 of the lower fastening seat 11a shown in FIG. 3. The front upper fastening part 42 is a flat plate part formed of a front portion of the upper fastening seat 31a. A generally circular insertion hole 42H being a through-hole is provided at the center of the front upper fastening part 42. The rear upper fastening part 43 is a flat plate part formed of a rear portion of the upper fastening seat 31a and is continuous with a rear end of the front upper fastening part 42. A generally circular insertion hole 43H being a through-hole is provided also at the center of the rear upper fastening part 43.

Middle Fastening Seat Upper Insertion Hole (Insertion Hole of Resin Component)

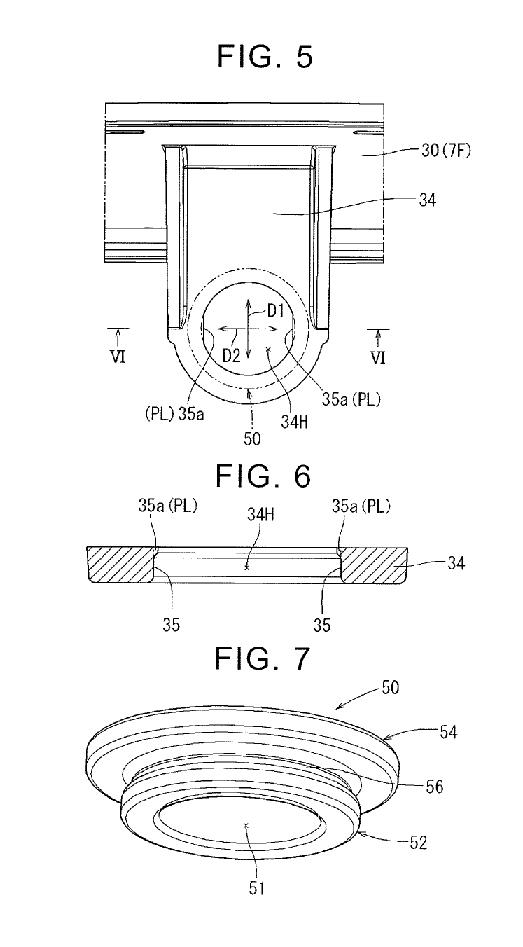

Referring to FIGS. 4 and 5, the middle fastening seat 34 is a flat plate part having a generally rectangular shape in top view and protrudes forward from an inner surface of the body portion 30 in the middle in the seat width direction. The rear fastening seat 14 of the fastening component 10 shown in FIG. 3 is fastened and fixed to the upper insertion hole 34H of the middle fastening seat 34. Referring to FIG. 5, the upper insertion hole 34H is a through-hole having a generally circular shape in top view, while its dimension in a front-rear direction D1 is slightly greater than its dimension in a right-left direction D2. Referring to FIG. 6, projecting portions 35a are provided at an upper end of an inner surface 35 of the upper insertion hole 34H so as to protrude radially inward of the upper insertion hole 34H.

Projecting Portions

Referring to FIGS. 5 and 6, the projecting portions 35a are formed symmetrically with each other at the right and left edges of the inner surface 35 of the upper insertion hole 34H. The projecting portions 35a at the right and left edges each have a size and shape that can be disposed in a recessed portion 56 of the later-described fastener 50. In this Example, a parting line PL that is formed when molding the frame portion 7F is used as the projecting portions 35a. The parting line PL is a part that is formed when a molding material of the frame portion 7F flows into a split portion between an upper die and a lower die of a molding machine (not shown) and then is cured. The parting line PL as the projecting portions 35a has moderate flexibility and is elastically deformable in the upper and lower directions being insertion and removal directions of the later-described fastener 50.

Fastener

The fastener 50 is a member that is interposed between the upper insertion hole 34H of the middle fastening seat 34 and the later-described bolt member 60 and serves as a bush. Referring to FIG. 7, the fastener 50 includes an insertion hole portion 51, an insertion portion 52, a flange portion 54, and the recessed portion 56. While the material of the fastener 50 is not particularly limited as long as it can bear the pressure from the bolt member 60, the material of the fastener 50 is typically a metal or a hard resin and is desirably harder than that of the middle fastening seat 34. The insertion hole portion 51 is a through-hole through which the shaft portion 60b of the bolt member 60 shown in FIG. 9 can be inserted. The insertion hole portion 51 is provided at the radial center of the fastener 50 and is open at both ends of the insertion portion 52. The insertion portion 52 is a tubular part that can be inserted through the upper insertion hole 34H of the middle fastening seat 34 in a non-press-fitted state. Herein, the insertion portion 52 being able to be inserted through the upper insertion hole 34H in a non-press-fitted state means that the insertion portion 52 can be inserted through the upper insertion hole 34H without using a dedicated facility for press-fitting, for example, manually. Therefore, referring to FIG. 9, it is satisfactory if a diameter L2 of the insertion portion 52 is of a degree that does not strongly interfere with the inner surface 35 of the upper insertion hole 34H. The typical diameter L2 of the insertion portion 52 can be set substantially equal to or less than a diameter L1 of the upper insertion hole 34H, but may be slightly greater than the diameter L1 of the upper insertion hole 34H due to an error that is allowed on design. The flange portion 54 is disc-shaped part formed at an upper end of the fastener 50 and has a greater diameter than the insertion portion 52 so as to protrude radially outward of the insertion portion 52. In the state where the fastener 50 shown in FIG. 9 is inserted through the upper insertion hole 34H, the flange portion 54 is exposed to the outside of the upper insertion hole 34H so as to be disposed at a position that can come in contact with a head portion 60a of the later-described bolt member 60.

Recessed Portion

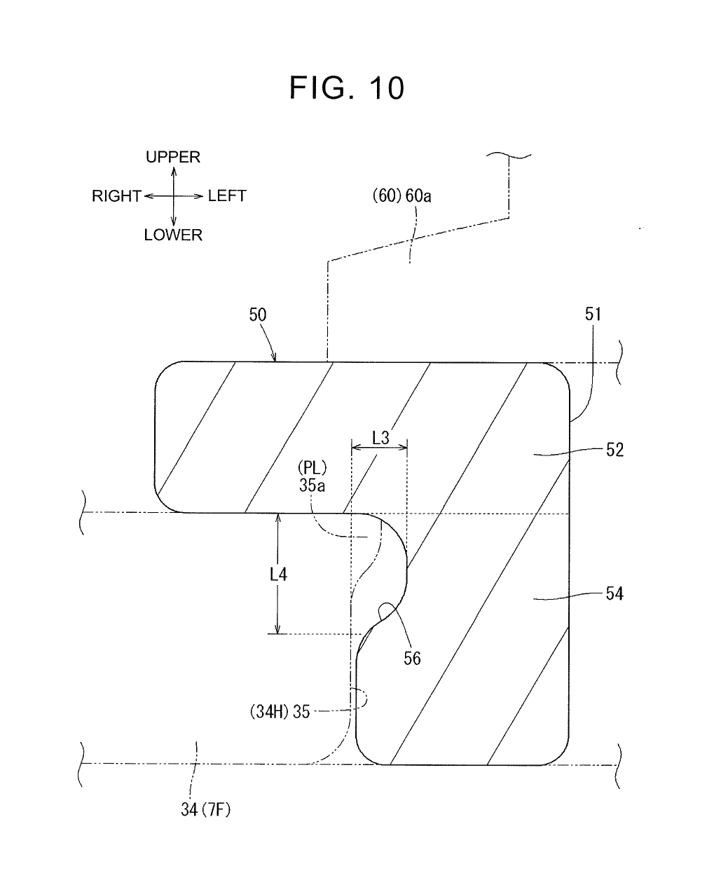

The recessed portion 56 is a groove-like part that is recessed radially inward of the insertion portion 52 and is formed over substantially the entire outer circumference of the insertion portion 52. In the state where the fastener 50 shown in FIG. 9 is inserted through the upper insertion hole 34H, the recessed portion 56 is disposed at a position that can face the projecting portions 35a of the upper insertion hole 34H, and in this Example, the recessed-portion 56 is formed just below the flange portion 54. Referring to FIG. 10, the maximum depth L3 from an opening of the recessed portion 56 to its bottom is not particularly limited as long as the projecting portions 35a of the upper insertion hole 34H can be disposed therein, but is desirably slightly greater than each of the projecting portions 35a disposed in the recessed portion 56. By setting the maximum depth of the recessed portion 56 to be greater in this way, it is possible to relatively move the fastener 50 radially of the upper insertion hole 34H. That is, referring to FIG. 5, the fastener 50 inserted through the upper insertion hole 34H can be slightly moved in the front-rear direction D1, the right-left direction D2, or the like being the radial direction of the upper insertion hole 34H in top view. An opening dimension L4 of the recessed portion 56 in the upper-lower direction of the bolt member 60 is also not particularly limited as long as the projecting portions 35a can be disposed therein, but, by setting the opening dimension L4 to be greater than each of the projecting portions 35a, smooth relative movement of the fastener 50 is made possible.

Fastening Operation of Seat Back and Bracket Member

Referring to FIG. 2, while applying the bracket member 7 to the seat back 6 from above, the fastening seats of the bracket member 7 are disposed to face the corresponding fastening seats of the seat back 6 from above. For example, the right and left upper fastening seats 31a and 31b of the bracket member 7 are respectively disposed to face the corresponding lower fastening seats 11a and 11b on the seat back 6 side. In this state, referring to FIGS. 3 and 4, the insertion holes 22H of the front lower fastening parts 22 and the insertion holes 42H of the front upper fastening parts 42 are disposed to face each other, while the insertion holes 23H of the rear lower fastening parts 23 and the insertion holes 43H of the rear upper fastening parts 43 are disposed to face each other. Then, referring to FIG. 8, the right upper fastening seat 31a and the right lower fastening seat 11a are fastened and fixed to each other by inserting a pair of bolt members BM through the corresponding insertion holes (22H and 42H, 23H and 43H). Likewise, the left upper fastening seat 31b and the left lower fastening seat 11b are fastened and fixed to each other by inserting a pair of bolt members BM through the corresponding insertion holes. Referring to FIG. 2, the right and left side fastening seats 36a and 36b of the bracket member 7 are disposed to face the insertion holes 16H of the corresponding protruding fastening seats 16a and 16b of the fastening component 10 from above and are fastened and fixed to the insertion holes 16H by inserting bolt members BM therethrough as shown in FIG. 8.

Fastening Operation of Middle Fastening Seat and Rear Fastening Seat (Attaching Operation of Fastening Member and Fastener)

Along with the fastening operation described above, referring to FIGS. 2 and 8, the middle fastening seat 34 of the bracket member 7 is disposed to face the rear fastening seat 14 of the fastening component 10 from above. In this state, referring to FIG. 9, the upper insertion hole 34H of the middle fastening seat 34 and the lower insertion hole 14H of the rear fastening seat 14 are disposed to face each other. Then, the bolt member 60 is inserted therethrough from the upper insertion hole 34H side with the fastener 50 disposed in place, so that the fastening seats 14 and 34 are fastened and fixed to each other. Herein, the bolt member 60 is one example of a fastening member of the disclosure and has the large-diameter head portion 60a and the small-diameter elongated shaft portion 60b. In this type of configuration, it is desirable that the fastener 50 be attached to the middle fastening set 34 being the resin component in such a way as to be detachable more smoothly while preventing coming-off of the fastener 50 from the middle fastening seat 34 as much as possible.

Therefore, in this Example, referring to FIG. 9, the fastener 50 includes the insertion portion 52 that is insertable through the upper insertion hole 34H in a non-press-fitted state, the disc-shaped flange portion 54, and the recessed portion 56 on the outer surface of the insertion portion 52. In the insertion operation of the fastener 50, the insertion portion 52 is inserted through the upper insertion hole 34H until the flange portion 54 is locked on the outer edge side of the upper insertion hole 34H. In this event, the insertion portion 52 can be inserted through the upper insertion hole 34H manually without using a dedicated facility for press-fitting. The projecting portions 35a of the upper insertion hole 34H are moderately bent downward due to pressing by the insertion portion 52 to allow passage of the insertion portion 52 therethrough. In the state where the insertion portion 52 is inserted through the upper insertion hole 34H, the projecting portions 35a are disposed to face the recessed portion 56 on the outer surface of the insertion portion 52 and are restored to the original protruding state in the recessed portion 56. In this state, the shaft portion 60b of the bolt member 60 is inserted through the insertion hole portion 51 of the fastener 50 until the head portion 60a comes in contact with the flange portion 54. Then, by screwing a nut NT on the shaft portion 60b protruding from the lower insertion hole 14H of the rear fastening seat 14, the middle fastening seat 34 and the rear fastening seat 14 can be fastened and fixed to each other.

In the state where the insertion portion 52 is inserted through the upper insertion hole 34H in this way, referring to FIG. 9, the flange portion 54 disposed outside the upper insertion hole 34H is in contact with the head portion 60a of the bolt member 60. Therefore, the flange portion 54 receives the pressure from the bolt member 60 to prevent excessive deformation of the middle fastening seat 34 that is otherwise caused by the tightening pressure of the bolt member 60, so that it is possible to prevent or reduce the lowering of fastening axial force due to deformation of the middle fastening seat 34. Referring to FIG. 10, in the state where the insertion portion 52 is inserted through the upper insertion hole 34H, the projecting portions 35a protruding from the inner surface 35 of the upper insertion hole 34H are disposed in the recessed portion 56 of the insertion portion 52. Therefore, even if the middle fastening seat 34 is inclined or turned upside down, the movement of the insertion portion 52 in a coming-off direction with respect to the upper insertion hole 34H can be suitably restricted by interference between the projecting portions 35a and the recessed portion 56. In the detaching operation of the fastener 50, since the insertion portion 52 does not strongly interfere with the inner surface 35 of the upper insertion hole 34H, the insertion portion 52 can be manually pulled out upward from the upper insertion hole 34H. In this event, the projecting portions 35a of the upper insertion hole 34H are moderately bent upward due to pressing by the insertion portion 52 to allow passage of the insertion portion 52 therethrough.

Referring to FIG. 5, the fastener 50 of this Example is slightly relatively movable in the front-rear direction D1, the right-left direction D2, or the like with respect to the upper insertion hole 34H. That is, the position of the fastener 50 can be adjusted in the direction D1, D2, or the like that is perpendicular to the upper-lower direction being the tightening direction of the bolt member 60. For example, it is assumed that when the middle fastening seat 34 and the rear fastening seat 14 are disposed to face each other, the lower insertion hole 14H of the rear fastening seat 14 is offset to the front with respect to the upper insertion hole 34H of the middle fastening seat 34. In this case, the fastener 50 is slightly moved to the front on the lower insertion hole 14H side so as to be disposed at an appropriate position, and the bolt member 60 is inserted through the fastener 50 disposed at this appropriate position. Therefore, according to the fastener 50 of this Example, the tightening surface pressure from the shaft portion 60b of the bolt member 60 can be ensured in a large adjustment region compared to the conventional press-fitting type bush.

As described above, in this Example, the tubular insertion portion 52 is inserted through the upper insertion hole 34H in a non-press-fitted state. Therefore, the fastener 50 can be smoothly attached to or detached from the middle fastening seat 34 as the resin component without requiring a dedicated facility or a special process. The pressure from the head portion 60a of the bolt member 60 is received by the flange portion 54 disposed outside the upper insertion hole 34H, and the projecting portions 35a protruding from the inner surface 35 of the upper insertion hole 34H are disposed in the recessed portion 56 of the insertion portion 52. Therefore, while fulfilling the function as the fastener 50, it is also possible to suitably restrict the movement of the insertion portion 52 in a coming-off direction with respect to the upper insertion hole 34H by interference between the projecting portions 35a and the recessed portion 56. Therefore, according to this Example, the fastener 50 can be attached to the middle fastening seat 34 as the resin component in such a way as to be detachable more smoothly while preventing coming-off of the fastener 50 from the middle fastening seat 34 as much as possible.

### EXAMPLE 2

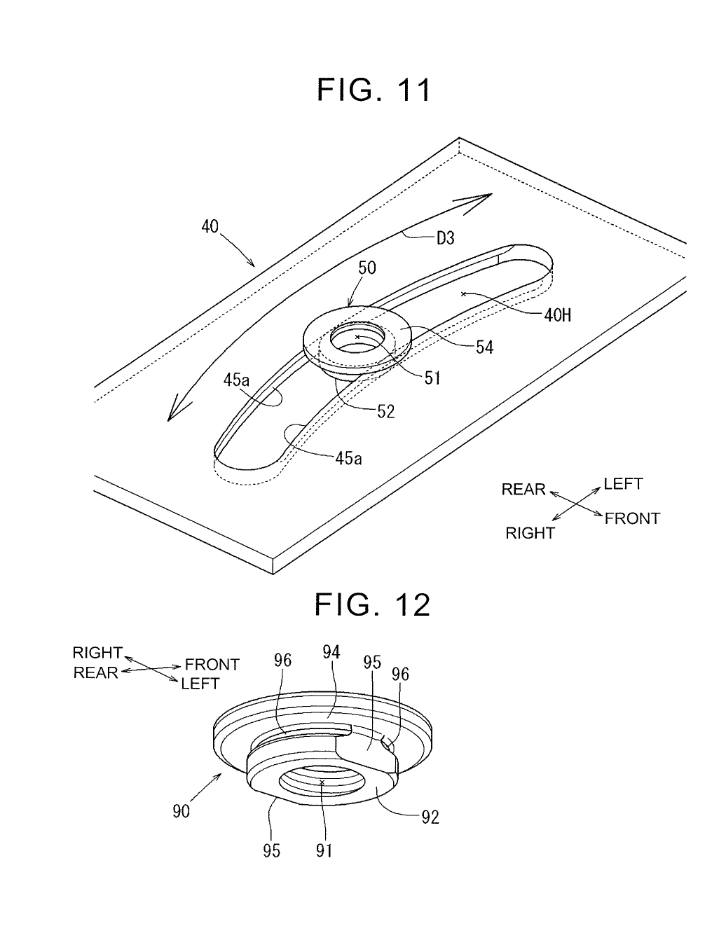

In Example 2, for those members having substantially the same basic configurations as the constituent members of Example 1, a detailed description thereof will be omitted by assigning corresponding reference symbols thereto or the like. Referring to FIG. 11, Example 2 differs from Example 1 in that an upper insertion hole 40H in the form of an elongated hole is provided in a middle fastening seat 40. The upper insertion hole 40H is an arc-shaped elongated hole that is elongated in the right-left direction and is gradually curved forward as approaching its right and left ends. Further, projecting portions 45a are respectively provided at the front upper edge and the rear upper edge of the upper insertion hole 40H, and each extend in the right-left direction along the corresponding upper edge. In this Example, a fastener 50 inserted through the upper insertion hole 40H can be relatively moved relatively largely in a longitudinal direction D3 of the upper insertion hole 40H. Therefore, according to the configuration of this Example, the tightening surface pressure from a shaft portion of a bolt member can be ensured in an even larger adjustment region compared to the conventional press-fitting type bush. The upper insertion hole 40H may alternatively be formed as an arc-shaped elongated hole that is elongated in the front-rear direction, or as a straight elongated hole.

### EXAMPLE 3

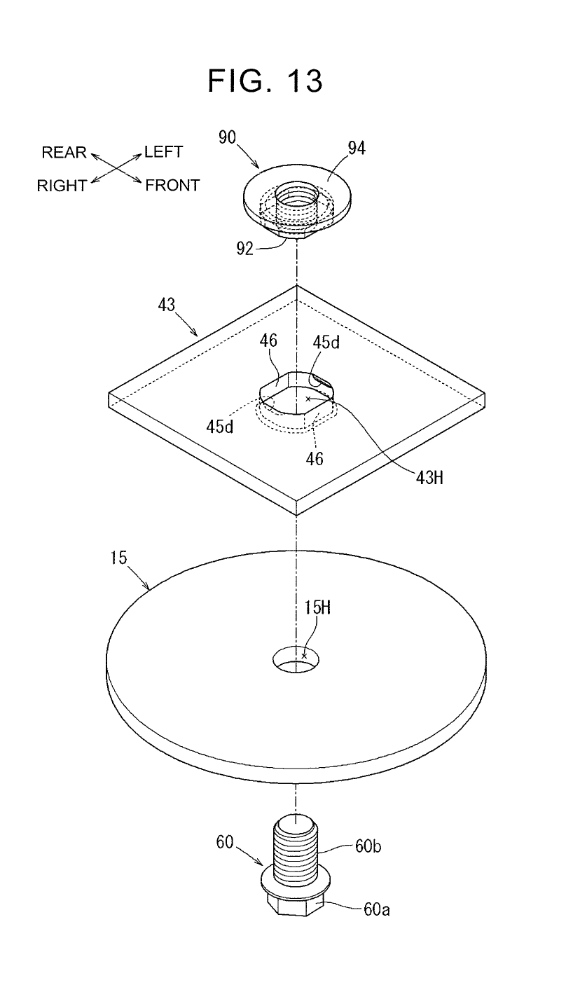

In Example 3, for those members having substantially the same basic configurations as the constituent members of Example 1, a detailed description thereof will be omitted by assigning corresponding reference symbols thereto or the like. Referring to FIGS. 12 to 15, Example 3 differs from Example 1 in that a fastener 90 is a member that serves as a nut, and in that there is provided a configuration for preventing the rotation of the fastener 90 with respect to an upper insertion hole 43H of a middle fastening seat 43. Referring to FIG. 12, the fastener 90 of this Example includes an insertion hole portion 91, an insertion portion 92, a flange portion 94 having the same configuration as in Example 1, and a pair of recessed portions 96. While the insertion hole portion 91 has substantially the same configuration as in Example 1, the insertion hole portion 91 is provided on its inner surface with a screw groove that can be screwed on a shaft portion 60b of a bolt member 60 shown in FIG. 13. The insertion portion 92 has right and left outer surfaces having a generally cylindrical shape and front and rear outer surfaces each cut out into a flat surface that serves as an abutting portion 95. The recessed portions 96 are respectively provided at the right and left outer surfaces of the insertion portion 92. The recessed portions 96 are separated by the front and rear abutting portions 95. Referring to FIG. 13, the upper insertion hole 43H of the middle fastening seat 43 has a shape matching the external shape of the insertion portion 92. That is, the upper insertion hole 43H has right and left outer surfaces having a generally circular shape in top view, and these right and left outer surfaces are respectively provided with projecting portions 45d that are disposed symmetrically with each other. Further, the upper insertion hole 43H has front and rear outer surfaces each serving as a rotation preventing portion 46, and these front and rear outer surfaces are each in the form of a side extending straight in the right-left direction in top view.

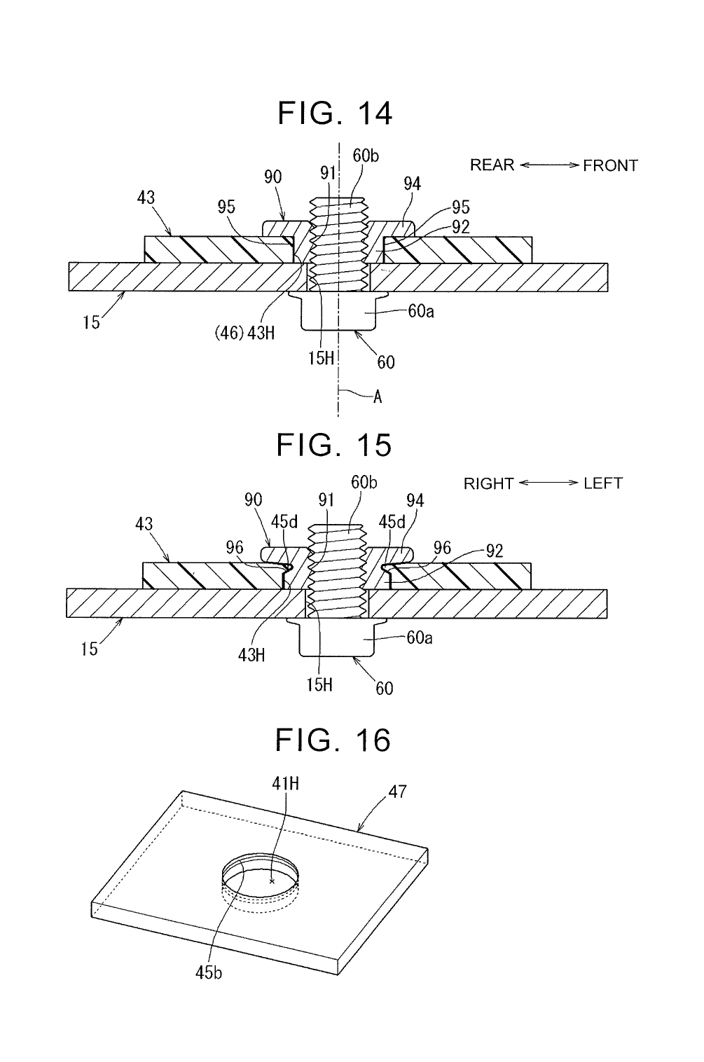

Referring to FIG. 13, the fastener 90 is inserted through and fitted in the upper insertion hole 43H of the middle fastening seat 43 in an appropriate orientation. In this state, referring to FIG. 14, the abutting portions 95 of the insertion portion 92 are respectively disposed to face the corresponding rotation preventing portions 46 of the upper insertion hole 43H. Referring to FIG. 15, the projecting portions 45d protruding from the upper insertion hole 43H are respectively disposed in the corresponding recessed portions 96 of the fastener 90. Therefore, according also to this Example, the movement of the insertion portion 92 in a coming-off direction with respect to the upper insertion hole 43H can be suitably restricted by interference between the projecting portions 45d and the recessed portions 96.

Further, referring to FIG. 13, the middle fastening seat 43 is disposed to face a rear fastening seat 15 of a fastening component, and positioning between the upper insertion hole 43H of the middle fastening seat 43 and an insertion hole 15H of the rear fastening seat 15 is carried out (for convenience, only a portion of the rear fastening seat 15 is shown in FIG. 13). In this state, the bolt member 60 is rotated about its axis to pass through the insertion hole 15H of the rear fastening seat 15 and to be screwed into the insertion hole portion 91 of the fastener 90 fitted in the upper insertion hole 43H, so that the fastening seats 15 and 43 are fastened and fixed to each other. In this event, in this Example, referring to FIG. 14, the abutting portions 95 of the insertion portion 92 are disposed to face the corresponding rotation preventing portions 46 of the upper insertion hole 43H. Therefore, even if the fastener 90 attempts to rotate about the axis A of the bolt member 60 when screwed on the bolt member 60, the abutting portions 95 abut against the rotation preventing portions 46, so that the rotational motion is restricted. In this way, in this Example, by restricting the rotation of the fastener 90 with respect to the upper insertion hole 43H by means of the abutting portions 95 and the rotation preventing portions 46 serving as anti-rotation detents, the fastener 90 can be suitably used as a nut. Further, by the pair of front and rear abutting portions 95 and the pair of front and rear rotation preventing portions 46, the rotation of the fastener 90 with respect to the upper insertion hole 43H can be restricted in a well-balanced manner. In this Example, the abutting portion and the rotation preventing portion may be provided on only one of the front, rear, right, and left sides of the corresponding members, while a projecting portion and a recessed portion may be provided on the other side.

Modification 1

As the configuration of a middle fastening seat, there may be various configurations other than the above-described configurations. For example, referring to FIG. 16, an upper insertion hole 41H of a middle fastening seat 47 of Modification 1 is a generally circular through-hole and is provided with a projecting portion 45b over its entire outer circumference. By providing the extensive projecting portion 45b to the upper insertion hole 41H, the interference with the recessed portion 56 of the fastener 50 shown in FIG. 7 is strengthened, so that it is possible to more reliably prevent coming-off of the fastener 50 from the upper insertion hole 41H.

Modification 2

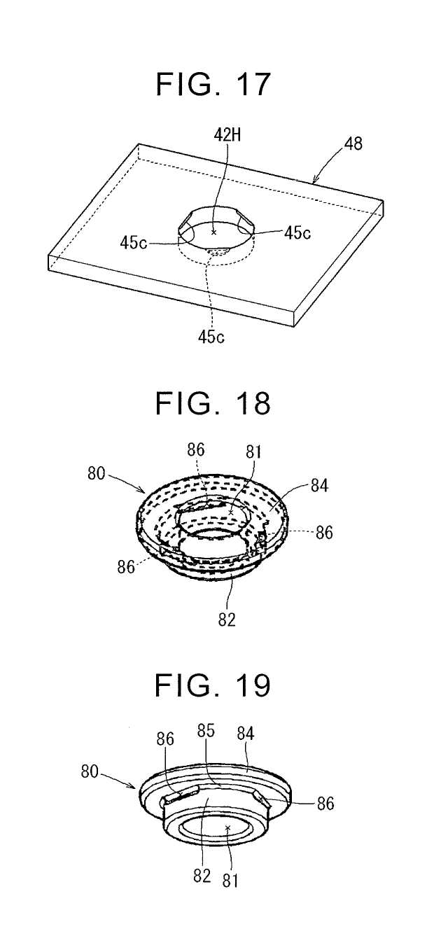

As the configuration for preventing the rotation of a fastener with respect to an upper insertion hole, there may be various configurations other than the above-described configurations. For example, referring to FIG. 17, a middle fastening seat 48 of Modification 2 is provided at the upper peripheral edge of an upper insertion hole 42H with three pairs of projecting portions 45c that are disposed at intervals of about 60 degrees in top view. Referring to FIGS. 18 and 19, a fastener 80 of Modification 2 is a member that serves as a bush or a nut, and includes an insertion hole portion 81 and a flange portion 84 each having substantially the same configuration as in Example 1, an insertion portion 82, and three pairs of recessed portions 86. The three pairs of recessed portions 86 are provided on an outer surface of the insertion portion 82 at intervals of about 60 degrees in top view. Further, referring to FIG. 19, the insertion portion 82 is provided with partition portions 85 between the adjacent recessed portions 86, and the three pairs of recessed portions 86 are separated by the partition portions 85 (for convenience, only one partition portion is shown in FIG. 19).

Referring to FIGS. 17 to 19, in the state where the fastener 80 is inserted through the upper insertion hole 42H of the middle fastening seat 48, the three pairs of projecting portions 45c of the upper insertion hole 42H are respectively disposed in the corresponding recessed portions 86 of the fastener 80. Accordingly, even if the fastener 80 attempts to rotate about the axis of the upper insertion hole 42H, the projecting portions 45c abut against the corresponding partition portions 85, so that the rotational motion is restricted. In this way, in this Modification, the rotation of the fastener 80 with respect to the upper insertion hole 42H can be suitably restricted by means of the projecting portions 45c and the partition portions 85 serving as anti-rotation detents. Further, the, movement of the insertion portion 82 in a coming-off direction with respect to the upper insertion hole 42H can be suitably restricted by interference between the projecting portions 45c and the recessed portions 86 that are disposed at intervals of about 60 degrees in a well-balanced manner. In this Modification, three or more pairs of projecting portions and three or more pairs of recessed portions may be disposed at substantially regular intervals (substantially equal angles) or at unequal intervals in top view.

Modification 3

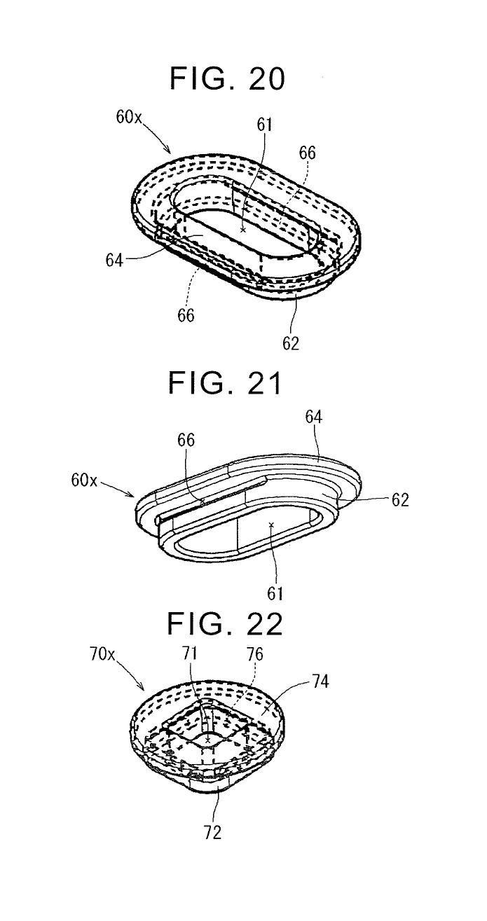

As the configuration of a fastener, there may be various configurations other than the above-described configurations. For example, referring to FIGS. 20 and 21, a fastener 60x of Modification 3 is a member having an oval shape in top view and elongated in the right-left direction or in the front-rear direction, and includes an insertion hole portion 61, an insertion portion 62, a flange portion 64, and a pair of recessed portions 66. The insertion hole portion 61, the insertion portion 62, and the flange portion 64 each have a shape reflecting the external shape of the fastener 60x and thus each have an oval shape in top view. The recessed portions 66 are respectively provided at relatively elongated outer circumferential portions of the insertion portion 62. In this Modification, it is possible to more reliably prevent coming-off of the fastener 60x from an upper insertion hole (not shown) by interference between the relatively elongated recessed portions 66 and relatively elongated projecting portions (not shown). In this Modification, the rotation of the fastener 60x with respect to the upper insertion hole (not shown) can be suitably restricted by interference between the oval-shaped insertion portion 62 and an inner surface of the upper insertion hole serving as anti-rotation detents.

Modification 4

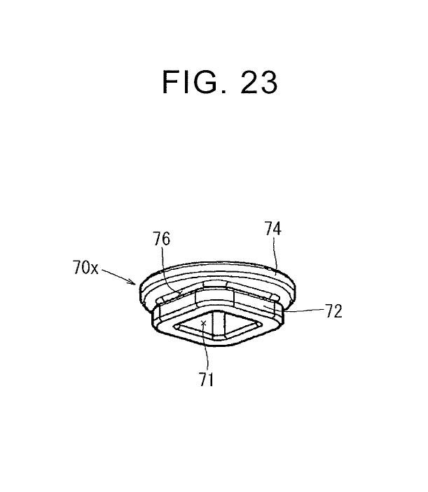

Referring to FIGS. 22 and 23, a fastener 70x of Modification 4 includes a rectangular parallelepiped insertion hole portion 71, a rectangular tubular insertion portion 72, a disc-shaped flange portion 74, and a recessed portion 76 provided over the entire outer circumference of the insertion portion 72. The fastener 70x of this Modification is configured to be insertable through a rectangular parallelepiped upper insertion hole of a middle fastening seat (not shown) and is configured such that a rectangular parallelepiped shaft portion of a bolt member (not shown) is insertable through the insertion hole portion 71. Also in this Modification, the rotation of the fastener 70x with respect to the upper insertion hole (not shown) can be suitably restricted by interference between the rectangular tubular insertion portion 72 and an inner surface of the upper insertion hole serving as anti-rotation detents. The external shapes of the insertion portion 72 and the insertion hole portion 71 may each be one of various polygonal shapes other than the rectangular shape in top view.

The fastener of the disclosure is not limited to the embodiment described above and may alternatively have a configuration of any of various other embodiments. In this embodiment, while the configuration (shape, size, disposition position, constituent part, etc.) of the upper insertion hole 34H of the middle fastening seat 34 has been described as the insertion hole of the resin component by way of example, this is not intended to limit the configuration of an insertion hole of a resin component. For example, the insertion holes of various fastening seats (upper fastening seats 31a and 31b, side fastening seats 36a and 36b, etc.) of the frame portion may each be used as an insertion hole of a resin component. The shape of the insertion hole may be suitably selected from the shapes exemplified in the Examples and Modifications and may alternatively be a shape other than the exemplified shapes. The description has been given of the example in which the projecting portion is provided on the inner surface of the insertion hole using the parting line. The projecting portion can be provided on the inner surface of the insertion hole regardless of the parting line, and in this case, the projecting portion can be post-formed on the inner surface of the insertion hole. The projecting portion can be provided over the entire circumference or at part of the circumference of the inner surface of the insertion hole and can be provided at a suitable position in the upper-lower direction of the inner surface of the insertion hole.

In this embodiment, while the configuration (shape, size, constituent part, etc.) of the fastener 50 has been described by way of example, this is not intended to limit the configuration of a fastener. For example, the insertion portion of the fastener may be a tubular portion of a shape corresponding to the shape of the insertion hole in ton view or may be a tubular portion of a shape different from that of the insertion hole. The projecting portion of the insertion hole may be disposed in the recessed portion of the fastener so as to be substantially unable to make relative movement. When a plurality of projecting portions are separately provided on the inner surface of the insertion hole, a continuous recessed portion in which the plurality of projecting portions can be disposed may be provided on the insertion portion of the fastener, or a plurality of recessed portions in each of which the corresponding projecting portion can be disposed may be separately provided on the insertion portion of the fastener. The shape and size of the frame portion may also be changed as appropriate as long as it can bear the pressures of the bolt members and so on.

In this embodiment, while the configuration and fastening configuration of the bolt member 60 has been described as the fastening member by way of example, this is not intended to limit the configuration of a bolt member. For example, while omitting the nut, the bolt member can be directly screwed into a threaded insertion hole provided to the rear fastening seat. In this case, the shaft portion of the bolt member may be inserted while passing through or not passing through the insertion hole of the rear fastening seat in the thickness direction. Various members such as various bolt members including a stepped bolt and various Misumi bolts such as a stepped Misumi bolt can be supposed to be fastening members, and a shaft portion having a screw groove and a stepped portion of a stepped bolt or the like can be supposed to be shaft portions.

In this embodiment, while the frame portion 7F of the bracket member 7 has been described as the resin component by way of example, this is not intended to limit the type of resin component. For example, members on the seat back side, various members disposed in a vehicle compartment, and resin components unrelated to the inside of the vehicle compartment can be supposed to be resin components. The configurations of the Examples and the configurations of the Modifications can be used in combination as appropriate. The configuration of the vehicle seat 2 can also be changed as appropriate. The configuration of this embodiment can be applied to vehicle structure bodies such as various vehicle sets that are mounted in vehicles such as cars, airplanes, and trains.

What is claimed is:

1. A fastener for fastening a resin component, the fastener configured to be interposed between an insertion hole provided in the resin component and a fastening member inserted through the insertion hole, the fastener comprising:
an insertion portion having a tubular shape and insertable through the insertion hole in a non-press-fitted state;
a flange portion protruding radially outward of the insertion portion from an end portion of the fastener; and
a recessed portion provided on an outer surface of the insertion portion, wherein, in a state where the insertion portion is inserted through the insertion hole, the flange portion is disposed outside the insertion hole, and a projecting portion protruding from an inner surface of the insertion hole is disposed in the recessed portion of the insertion portion.

2. The fastener according to claim 1, wherein a depth from an opening of the recessed portion to its bottom is greater than the projecting portion.

3. The fastener according to claim 1, wherein the fastener is a nut for the fastening member.

4. The fastener according to claim 1, wherein the insertion portion includes an abutting portion formed by cutting out the outer surface of the insertion portion into a flat surface.
